(19) United States
(12) Patent Application Publication
(10) Pub. No.: US 2006/0003144 A1
(43) Pub. Date: Jan. 5, 2006

(54) Modular, raised panels and methods of manufacturing the same

(76) Inventor: Donald L. Kaump, Seattle, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/882,435

(22) Filed: Jul. 1, 2004

(51) Int. Cl. B32B 3/10

(52) U.S. Cl. 428/131; 428/156; 428/151

(57) ABSTRACT

A modular composite panel and system of panels provides an aesthetically pleasing wallboard, ceiling, or other covering for an interior surface of a building. The panels are made from a hardened gypsum based skin moulded with a lower density backing material. The panels have a three dimensional relief and can be abutted together to form a system of panels. An experienced installer can use a filler that has a vinyl or acrylic additive to fill the seams between the panels. The installer can then sand the seams and adjacently located regions, as necessary, to create a continuous, seamless three-dimensional surface. Each panel is capable of receiving paint or texture, or being cut, trimmed or machined.

### BACKGROUND OF THE INVENTION

1. Field of the Invention

This description generally relates to decorative panels for covering an interior surface, and methods of manufacturing the same.

2. Description of the Related Art

Coverings for interior surfaces in both residential and commercial buildings are well known in the art. Coverings include wallboard, ceiling tiles, or wainscoting, for example. Interior surfaces such as walls and ceilings are typically covered with gypsum-based plaster panels sandwiched between two sheets of board cover paper, sometimes referred to as “drywall” or “plaster-board” (gypsum is also known as “calcined stucco”; whereas the chemical name for gypsum is calcium sulfate hemihydrate). Wallboard typically has a flat, smooth, papered-covered surface and slightly beveled edges. The beveled edges are abutted together during installation and the seams between the wallboard panels are typically filled with a standard joint compound and taped with drywall tape. The seams between adjacent sheets of wallboard disappear after the process of taping, mudding, and finishing. Drywall is usually fastened to the studs or joists of the walls or ceiling, respectively, with drywall screws.

Traditionally, wallboard has been designed to not only be flat, but also to facilitate a smooth installation and finish. In the end, the state of the art in wallboard technology continuously teaches toward smoother and smoother surfaces, seamless connections, and clean corners.

At the same time, molded structures exist that allow individuals to install arches, posts and capitols and other architectural features, and to caulk or otherwise join such features to the surrounding wall and/or ceiling to add distinction to the room. These architectural features are then painted along with the walls and ceiling, giving the room a more complex and interesting appearance.

One example of a decorative covering for an interior surface is wainscoting. Wainscoting is typically installed over the top of wallboard on interior walls for decorative purposes. The material used for the wainscoting is most often wood, but can also be wood fiber particleboard, or straw particleboard. Straw particleboard uses waste wheat straw as the raw material.

Another gypsum-based material, such as glass-fiber reinforced gypsum, has been used to make shell castings for decorating ceilings, columns, and other interior objects. These shell castings are typically formed as one continuous shell and shaped using female molds. The mold can be made using any known means, such as CAD-CAM mold-making software. The gypsum-based material is sprayed or otherwise applied to the interior surface of the mold. Once dry, the structure is removed from the mold, the exterior surface of the structure having the desired shape. The interior of the structure is typically hollow and rough. Brackets and other support structure are used to support the shell castings. Rods, links, or truss members are then used mount the shell castings to an underlying surface, for example a wall, ceiling, or column.

A company named Marrotte, located just outside of Paris, France, produces several other types of decorative coverings for interior surfaces (http://www.marotte.fr/english/english_index_asp.htm). One type of decorative covering is a panel created by weaving strips of wood veneer. Another type of decorative covering is a wood panel that has a sculptural design carved or laser cut into the wood panel. In comparison to drywall, for example, these panels are much more expensive because they must be custom ordered, machined or hand carved, and they are made out of wood.

### SUMMARY OF THE INVENTION

In one aspect, the invention includes a composite panel for covering an interior surface, the panel having a hardened structural skin cast from a gypsum based material; and a backing member having a first surface and a second surface, the first surface moulded to the structural skin, the second surface having a substantially flat portion, the backing member made from a material having a lower density than that of the structural skin; and wherein the panel formed by the moulded structural skin and backing member includes a perimeter and a three-dimensional relief pattern, the amount of relief being variable over the area of panel relative to the substantially flat portion of the second surface of the backing member.

In another aspect, the invention includes a modular system of composite panels for covering an interior surface of a building, in which the system includes a plurality of panels with each panel abutted with at least one other panel, each panel having a hardened structural skin cast from a gypsum based material and a backing member having a first surface and a second surface, the first surface moulded to the structural skin, the second surface having a substantially flat portion, the backing member made from a material having a lower density than that of the structural skin, wherein the panel formed by the moulded structural skin and backing member includes a perimeter and a three-dimensional relief pattern, the amount of relief being variable over the area of panel relative to the substantially flat portion of the second surface of the backing member; and adjacent panels forming a seamless transition from one panel to the next where the three-dimensional relief pattern is configured to produce a continuous, sculpted, visible surface covering the interior surface after the panel seams have been finished.

In a further aspect, the invention includes a method of manufacturing a modular, composite panel by directing a gypsum based material into a mould to create a cast, hardened structural skin with a three-dimensional relief pattern; and moulding a backing member to the skin, the backing member made from a material having a lower density than that of the skin, a first surface of the backing member being affixed to the skin during the moulding process.

In yet a further aspect, the invention includes a method of affixing modular, composite panels to an interior surface of a building by placing a first panel on the interior surface; attaching the first panel to the interior surface; placing a second panel on the interior surface and adjacently locating the second panel with the first panel; aligning a three-dimensional relief pattern of the first panel with the three-dimensional relief pattern of the second panel; attaching the second panel to the interior surface; filling a seam between the adjacent panels with a filler; and sanding the filled seam and proximately located regions on the panel to provide a seamless appearance.

In another aspect, a panel for covering an interior surface includes a first surface having a substantially flat portion; a second surface opposed from the first surface, the second surface having a three-dimensional relief pattern, the amount of relief being variable over the area of panel relative to the substantially flat portion of the first surface; and a plurality of terminal edges defining the perimeter of the panel.

### BRIEF DESCRIPTION OF THE DRAWINGS

FIG. 1 is an isometric view of a room where one of the interior surfaces in the room is covered with panels according to one illustrated embodiment.

FIG. 2A is a front plan view of a three-dimensional relief pattern, according to another embodiment of the present invention.

FIG. 2B is a front plan view of a three-dimensional relief pattern, according to another embodiment of the present invention.

FIG. 2C is a front plan view of a three-dimensional relief pattern, according to another embodiment of the present invention.

FIG. 2D is a front plan view of a three-dimensional relief pattern, according to another embodiment of the present invention.

FIG. 3 is an isometric view of a panel having a three-dimensional relief pattern according to one illustrated embodiment.

FIG. 4 is a front plan view of the panel of FIG. 3.

FIG. 5 is a cross-sectional view of the panel of FIG. 3 taken along line 5-5 of FIG. 4.

FIG. 6 is a front plan view of another panel having a three-dimensional relief pattern and having reinforced edges according to one illustrated embodiment.

FIG. 7 is a cross-sectional view of the panel of FIG. 6 taken along line 7-7 of FIG. 6.

FIG. 8 is a front plan view of another panel having a three-dimensional relief pattern according to one illustrated embodiment.

FIG. 9 is a cross-sectional view of the panel of FIG. 8 taken along line 9-9 of FIG. 8.

FIG. 10 is a flow diagram of a method for manufacturing a panel according to one embodiment of the invention.

FIG. 11 is a flow diagram of a method for installing panels on an interior surface according to one embodiment of the invention.

### DETAILED DESCRIPTION OF THE INVENTION

In the following description, certain specific details are set forth in order to provide a thorough understanding of various embodiments of the invention. However, one skilled in the art will understand that the invention may be practiced without some of these details. In other instances, well-known structures, installation techniques and manufacturing techniques associated with interior surface coverings such as wallboard, ceiling panels, or wainscoting, etc., may not be shown or described in detail to avoid unnecessarily obscuring descriptions of the embodiments of the invention.

The headings provided herein are for convenience only and do not interpret the scope or meaning of the claimed invention.

This description initially presents a general overview of a system of modular, composite panels attached to an interior surface of a building and then provides a structural description of an individual modular, composite panel according to one embodiment of the invention. Next, the manufacturing process of the individual panel is described. Finally, the system of panels and the installation thereof is revisited and described in more detail.

Modular Panels

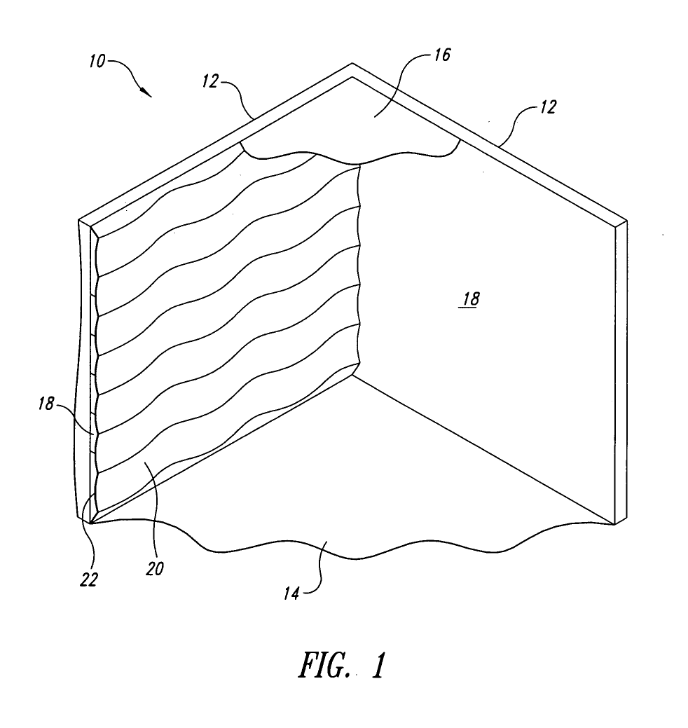

FIG. 1 illustrates cut away view of a room 10 having interior surfaces 18 such as walls 12, a floor 14, and a ceiling 16 with one of the walls 12 covered by a system of panels 20 according to one embodiment of the invention. The surface underneath the system of panels can be existing wallboard or some other substrate.

The system of panels 20 forms a continuous, three-dimensional relief pattern where the pattern is visibly seamless over the covered area. The edge 22 of the covered wall 12 is exposed for illustration purposes only.

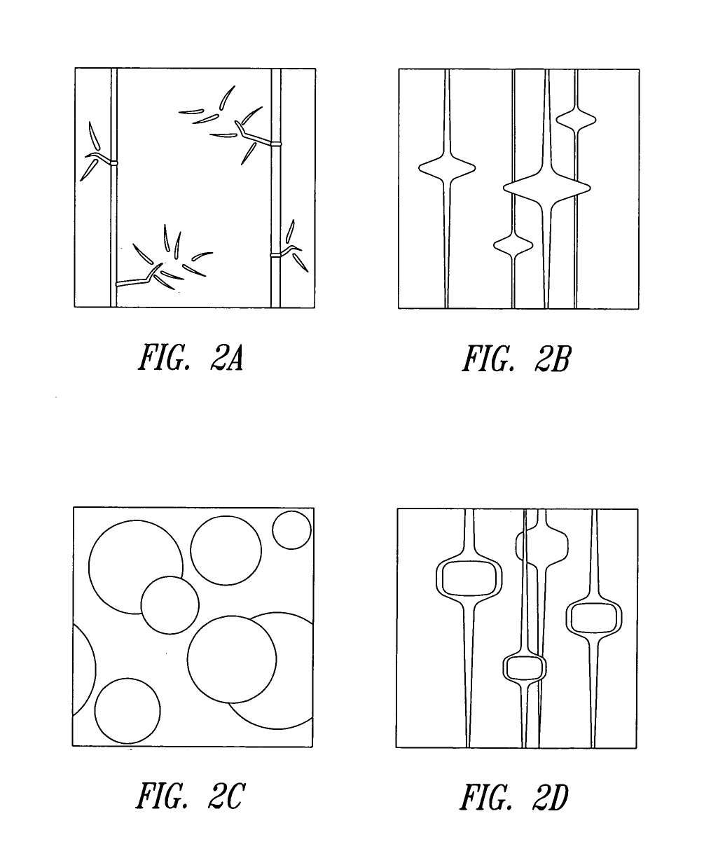

When the panels are aligned (e.g., side edge to side edge or top edge to bottom edge) the system of panels 20 can create a continual or flowing visual effect. The pattern can flow multi-directionally, vertically, horizontally, diagonally, and/or some other direction across the panel. In addition, the actual pattern design is not limited to the illustrated embodiment. FIGS. 2A through 2D illustrate a number of other possible patterns such as a “zen” pattern (FIG. 2A), a “lamps” pattern (FIG. 2B), a “big dots” pattern (FIG. 2C), and a “tvees” pattern (FIG. 2D).

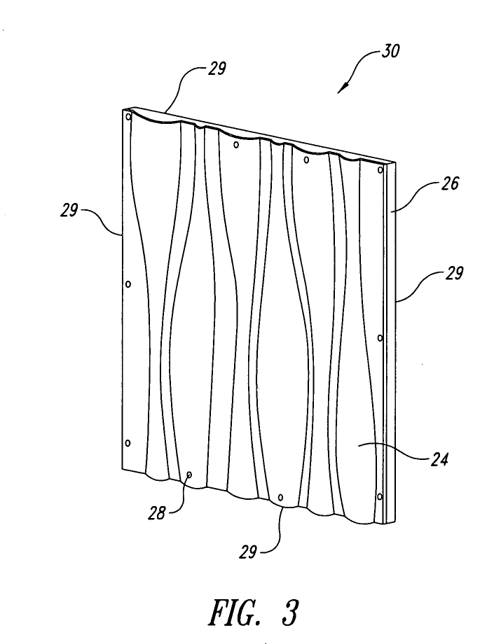

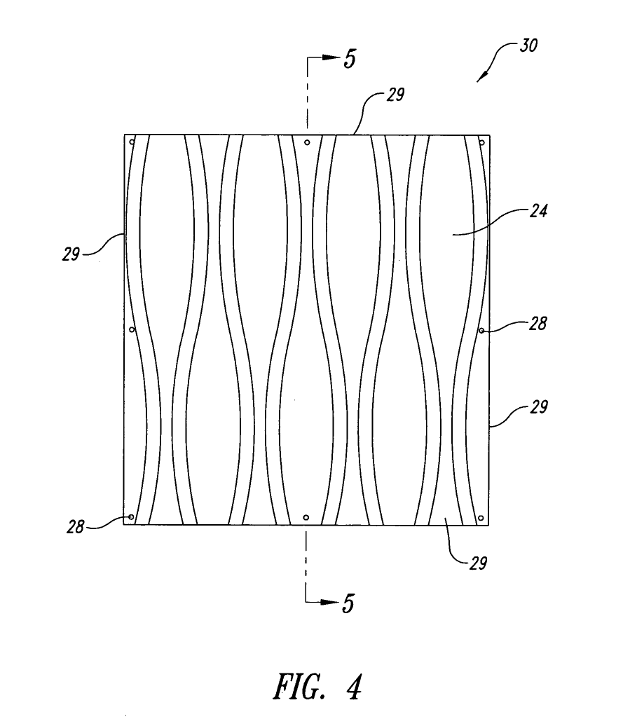

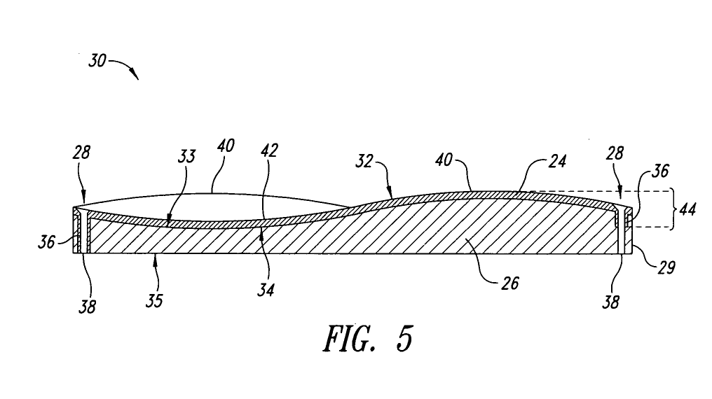

FIGS. 3 and 4 illustrate a panel 30 having a reinforced skin 24, a backing member 26, a number of mounting points 28, and a perimeter defined by terminal edges 29. The reinforced skin 24 can be made from a gypsum-based material. In one embodiment of the present invention, the reinforced skin 24 is made from a fiber reinforced gypsum (FRG) for added tensile strength. The embedded fibers may be glass, cellulose, polyester, carbon, or any number of strength-improving fibers. In the illustrated embodiment, the reinforced skin 24 is made from glass-fiber reinforced gypsum (GFRG), but can be referred to as GRG (glass reinforced gypsum) or FRG. The reinforced skin 24 has an outer surface 32 and an inner surface 34 (FIG. 5). The outer surface 32 is generally smooth while the inner surface 34 can have a rougher surface finish. The rougher surface finish of the inner surface 34 can enhance the attachment of the backing member 26 when the backing member 26 is moulded with the reinforced skin 24.

The backing member 26 is preferably made from a material having a lower density than FRG. A preferred material for the backing member 26 is a mixture of low-density pottery plaster and perlite. A typical low density pottery plaster that mixes well with perlite is No. 1 Casting Plaster sold by US Gypsum Company. Perlite is not a trade name but a generic term for naturally occurring siliceous rock. An interesting property of perlite is that when it is heated in its crude form to a suitable temperature, approximately 1600 degrees Fahrenheit (871 degrees Celsius), the crude perlite expands from about 4 to 24 times its original volume. This expansion gives perlite its light weight. The perlite, as utilized in the present invention, is purchased in an already expanded form. In an alternative embodiment, either the reinforced skin 24, the backing member 26, or both can be made from a cement-based material such as portland cement.

In addition, the backing member 26 has a first surface 33 and a second surface 35. The first surface 33 is moulded with and in contact with the reinforced skin 24. The second surface 35 is configured to be substantially flat for mounting the panel 30 to a flat, interior surface.

In addition to the reinforced skin 24 and the backing member 26, the panel 30 can have mounting points 28 according to one embodiment of the invention. FIG. 5 illustrates a cross sectional view of a panel 30 with one partially reinforced mounting points 28 on the right hand side of the panel and a fully reinforced mounting point 28 on the left side of the panel. Both types of reinforced mounting points 28 are depicted in FIG. 5 for illustrative purposes, although it is likely that an individual panel 30 would be configured with only one type of mounting point 28. The reinforced mounting point 28 structurally performs like a grommet 36 by reinforcing the opening 38 therethrough.

In the illustrated embodiment, the grommet 36 is integrally formed or cast with the reinforced skin 24 and extends from the inner surface 34 of the skin 24. The extended length of the grommet 36 from the inner surface of the skin 24 can be varied. In one embodiment illustrated on the right hand side of FIG. 5, the grommet 36 extends partly through the opening 38 to only partially reinforce the panel 30. In another embodiment also illustrated in FIG. 5, the grommet 36 extends substantially through the opening 38 to better reinforce the panel 30. One skilled in the art will appreciate and understand that the grommet 36 can be integrally cast with the skin 24 and consequently be made from GFRG. Additionally or alternatively, the grommet may be a separate structural member that could be inserted and bonded in the opening 38 after the skin 24 is cast or during the casting process.

Still referring to FIG. 5, the peaks 40 and valleys 42 of the three-dimensional relief pattern 44 from one location to the next over the area of the panel 30 can be variable in height or depth relative to the second surface 35 of the backing member 26. The dimensional offset or relief between the peaks 40 and the valleys 42 is sufficient to produce a three-dimensional appearance to an observer who is standing across the room from where the panel 30 is located. For example, in one embodiment of the invention, the maximum relief is in the range of about 1.0 inch to 2.0 inches.

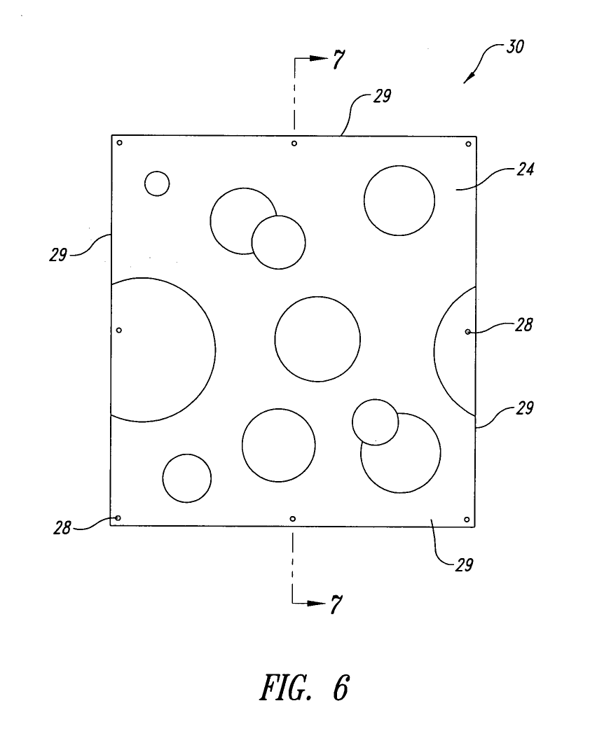

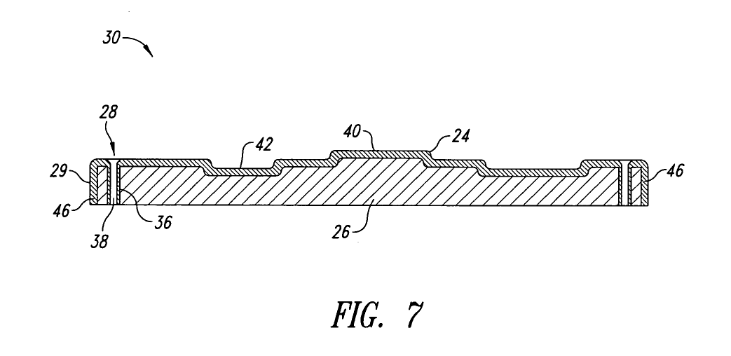

FIGS. 6 and 7 illustrate a panel 30 according to another embodiment of the invention. FIG. 6 depicts a panel 30 with a different three-dimensional relief pattern 44.

FIG. 7 is a cross sectional view of the panel of FIG. 6 having flanges 46 extending from the reinforced skin 22 where the flanges 46 form the terminal edges 29 of the panel 30. In the illustrated embodiment, the flanges 46 are integrally cast with the reinforced skin 22 and are thus comprised of FRG, same as the skin material. However, one skilled in the art will appreciate and understand that the flanges 46 may be bonded to the terminal edges 29 of the panel 30 after the panel is constructed. In an alternative embodiment, the perimeter of the panel 30 is interference fit into or bonded with a strip (not shown), for example a metal or a ceramic strip.

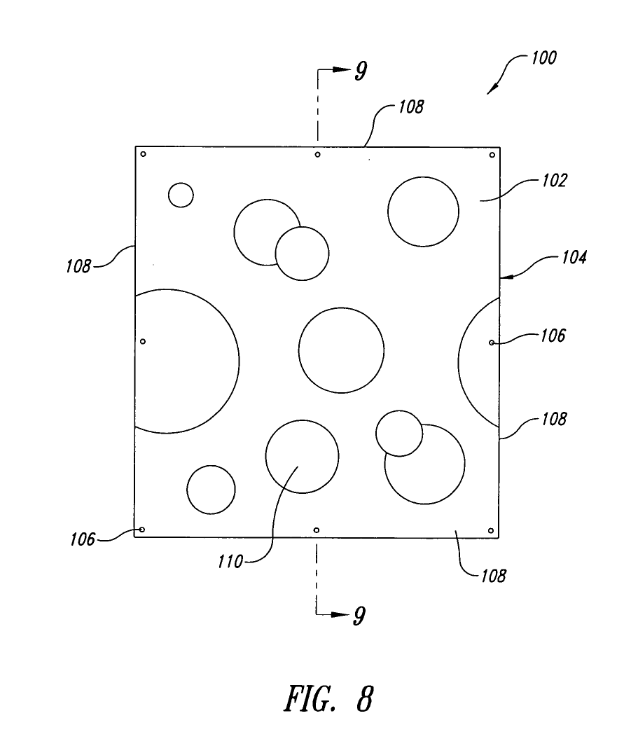

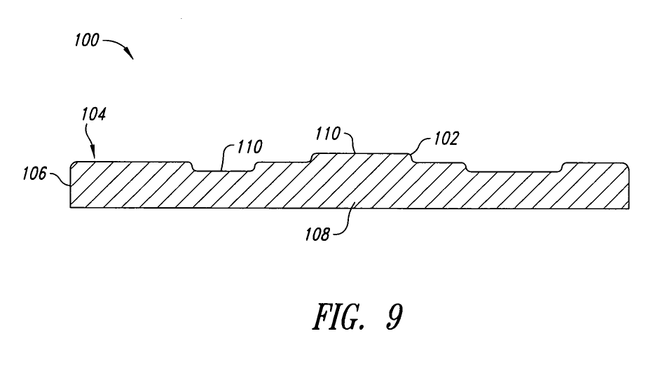

FIG. 8 illustrates a one-piece panel 100 having a front surface 102, a back surface 104, a number of mounting points 106, and a perimeter defined by terminal edges 108. The panel 100 can be made from a gypsum-based material, a cement-based material, or some other type of casting material. If a gypsum-based material is used, it may further contain fibers for added strength. A cement-based material as portland cement can also be used to form the panel 100. The front surface 102 in the illustrated embodiment has a three-dimensional relief pattern 110. FIG. 9 illustrates a cross sectional view of the one-piece panel 100.

Manufacture of a Modular Panel

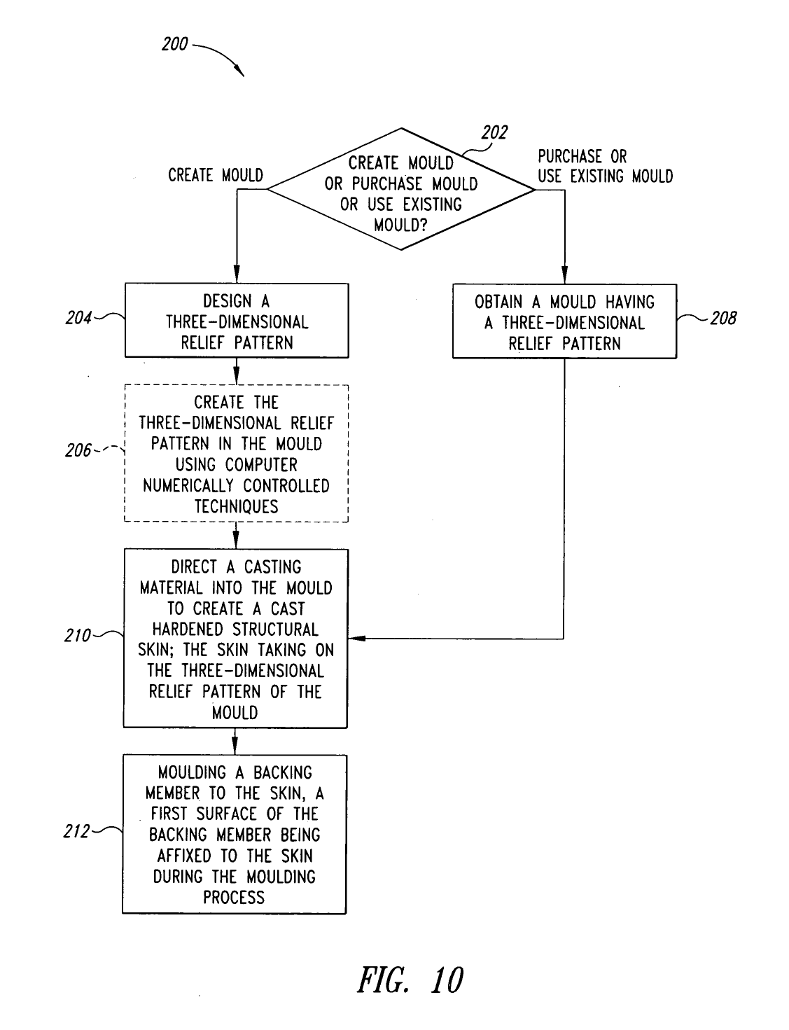

FIG. 10 is a flow diagram illustrating a method 200 of manufacturing a modular, composite panel 30. In 202, either a new mould can be created or a pre-made mould can be purchased or re-used. In 204, the three-dimensional relief pattern 44 is designed. In 206, computer numerically controlled (CNC) machining techniques are employed to produce the mould. CNC machining techniques for making moulds and other components are well-known in the art. Creating new moulds can be done quickly, inexpensively, and efficiently with CNC machining techniques. In addition, the variety of three-dimensional relief patterns 44 that can be created is nearly limitless.

In 208, a pre-made mould can be purchased or re-used. After selecting the mould, a casting material is poured into the mould to create a cast, hardened structural skin 24 with a three-dimensional relief pattern 44 that conforms with the mould. In one embodiment, the casting material is a gypsum based material, which may include fibers for added strength. In another embodiment, the casting material is a cement-based mixture such as portland cement. The casting material is directed into the mould when it is in a slurry or viscous liquid form. Typically, the structural skin 24 sufficiently hardens within four to ten minutes after it is directed into the mould. The surface of the skin in contact with the mould becomes the visible side of the skin after the panels are assembled and installed.

In 210, the backing member 26 is moulded to the skin 24. The backing member 26 is made from a material having a lower density than that of the skin. As discussed above, the material used for the backing member 26 can be a mixture of low density pottery plaster and perlite. As a further option, fibers can be included in the mixture.

In one embodiment of the present method, the backing member 26 is formed with the structural skin 24 by pouring a slurry of the backing member mixture onto the sufficiently hardened structural skin 24. Thus, one surface of the backing member 33 (FIG. 5) becomes affixed to the skin 24 during the moulding process such that the backing member 26 and the skin 24 become joined after the backing member 26 has set-up.

The height and width tolerance of the panel 30 during manufacturing is preferably held to ±⅛ of an inch. The tolerance for the thickness of the panel 30 is preferably held to ± 1/16 of an inch. However, one skilled in the art will appreciate and understand that these tolerances may be narrowed or opened depending on the capability of the manufacturing facility.

Installation of Modular Panels on an Interior Surface

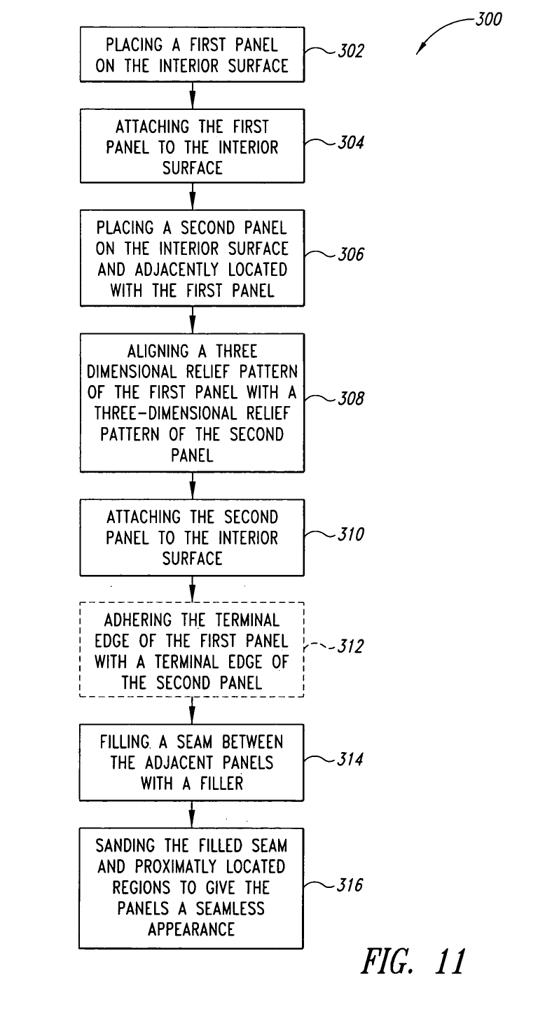

FIG. 11 is a flow diagram illustrating a method 300 of installing modular panels 30 onto an interior surface 18. In 302, a panel 30 is placed onto an interior surface 18. In 304, the panel 30 is attached to the interior surface 18 with fasteners, adhesive, or other well-known attachment techniques. In one embodiment, as previously described, the panel 30 can have pre-cast mounting points 28. The panel 30 can be attached to existing drywall using drywall anchors, which are well known in the art. If a portion of the panel 30 is attached to a wall stud, for example, the amount of torque applied to the fastener should be controlled as the fastener is seated into the panel 30, otherwise there is a risk that the structural skin 24 may crack if the fastener is torqued into the stud with too much force. Additionally and alternatively, if other mounting points 28 are desired aside from the pre-cast mounting points 28, additional mounting points 28 can be provided by using a countersink drill-bit. When drilling additional mounting points 28, care should be taken to not crack or break through the structural skin 24 panel. Further, the panel 30 should be hung plumb and level if installed on a vertical surface, such as a wall 12.

In 306, a second panel can be placed on the interior surface 18 and adjacent to the first panel. The second panel 30 can be placed on either side, above, or below the first panel 30. It is not necessary that the terminal edges 29 of the panels 30 be in actual physical contact. In some environments, it may be necessary to leave a gap between the terminal edges 29 of the panels 30 to allow the panels 30 to better flex with the wall 12, for example. Building flexure is a common phenomenon. In addition, a gap between the panels 30 also permits some play in the panel system 20 due to thermal or humidity effects.

In 308, one way of aligning the panels 30 is to align the three-dimensional relief patterns 44 of each panel 30. Aligning the relief patterns 44 assures that the-overall panel system 20 will have a continual, flowing visual appearance when the installation is complete. A mismatch tolerance of ± 1/32 of an inch between adjacent panels is provided as a guideline, however an experienced installer working with a more lenient three-dimensional pattern 44 may be able to adjust for a larger mismatch without adversely affecting the overall appearance of the panel system 20. In some patterns, for example the pattern of FIG. 2A, the mismatch tolerance should be monitored closely in order to permit the stems of the three-dimensional leaf pattern to be adequately aligned with the adjacently located panels 30.

Either in addition to or alternative to aligning the relief patterns, the terminal edges 29 of the first and second panels 30 can be aligned. However, one skilled in the art will appreciate that because the dimensions of the panels 30 can vary slightly from one panel to the next during fabrication, as discussed above, the primary goal during installation is to match the three-dimensional patterns 44.

Once the panels 30 are sufficiently aligned, the second panel 30 is attached to the interior surface 18 in 310. Attachment of the second panel 30 is accomplished in a manner similar to that described above to attach the first panel 30.

In 312, which is optional, a bonding agent is used in the seam or gap between the two adjacently located panels 30. The bonding agent can be a polyurethane glue or a construction mastic such as LIQUID NAILS®. The terminal edges 29 of the adjacently located panels 30 are joined when a liberal bead of glue is applied to joint or seam and allowed to set. After-the glue has set, excess glue can be cleaned off and if any glue extends beyond the surface of the structural skin 24, then this glue can be trimmed off, if necessary, with a snap-off tool or mat knife. Alternatively, the joint can be sanded to scuff up the surface near the seam and the glue surface, to remove any dry glue residue, to reduce any variation between the surfaces 24 of the panels 30, or any combination of the above.

In 314, the seams between the adjacent panels 30 are filled with a filler. The use of drywall tape and standard drywall joint compound should not be used for the installation of the panels of the present invention. The preferred filler should have a vinyl or acrylic additive, be softer than the structural skin 24, and be easily sanded. Fillers such as DAP Vinyl Spackling or DAP Fast 'N Final Lightweight Spackling, both commonly available, work well for filling the seams between adjacent panels 30. After the seams are filled, the seams and the surrounding area are sanded in 316. The sanding process blends out the seam and provides the panel system with the continual, sculptural effect where the individual panels 30 become a panel system 20. Some final operations that can be performed on the panels 30 are sealing the panels 30 with a polyvinyl acetate based sealer and painting the panels 30. Flat paint is preferable so that the interior room lighting does not highlight minor imperfections, which is more likely if gloss or semi-gloss paint is used.

Advantages of Modular Panels

One aspect of using a gypsum based product is that gypsum-based products have been known to protect materials from the heat of a flame for up to two hours. The superior fire properties of gypsum result because gypsum based products act like a thermal regulator when exposed to flame. Although the panels of the present invention are not intended to substitute for existing wallboard, the gypsum based panels can still provide an enhanced thermal barrier on a surface.

One advantage of the composite panels of the present invention is that the panel's visible surface is hard, solid, and ceramic-like because the dense rocklike plaster used for the reinforced skin 24 is fine and smooth. In addition, the panels can provide enhanced sound proofing between adjacent rooms. The hard and irregular surface, provided by the three-dimensional pattern on the panel, can tend to diffuse reflected sound within a room.

Yet another advantage of the gypsum-based panels of the present invention is that they are comprised of nontoxic minerals and are not subject to hazardous polymerization, which means that they do not off-gas like plastic during the manufacturing process. In fact, gypsum is used in several major brands of toothpaste and chalkboard chalk. Likewise, perlite is chemically inert and has been used on pressure and rotary vacuum filters in the food industry.

When the reinforced skin 24 is combined with the backing member 26, which is made from the lower density material, the weight of the panel can be significantly reduced versus making the entire panel 30 from only the gypsum-based material. Lighter panels are easier-to install and may also reduce the stress around the mounting points 28 of the panel after installation, for example during building flexure.

The various embodiments described above can be combined to provide further embodiments. These and other changes can be made to the invention in light of the above-detailed description. In general, in the following claims, the terms used should not be construed to limit the invention to the specific embodiments disclosed in the specification and the claims, but should be construed to include all gypsum-based composite panels and panel systems and methods for manufacturing and installing such panels in accordance with the claims. Accordingly, the invention is not limited by the disclosure, but instead its scope is to be determined entirely by the following claims.

We claim:

1. A composite panel for covering an interior surface, the panel comprising:
a hardened structural skin cast from a gypsum based material; and
a backing member having a first surface and a second surface, the first surface moulded to the structural skin, the second surface having a substantially flat portion, the backing member having a lower density than that of the structural skin,
wherein the panel formed by the moulded structural skin and backing member includes a perimeter and a three-dimensional relief pattern, the amount of relief being variable over the area of panel relative to the substantially flat portion of the second surface of the backing member.

2. The panel of claim 1 wherein a first portion of the three dimensional relief pattern is located closer to a plane coincident with the substantially flat portion of the second surface of the backing member and a second portion of the three dimensional relief pattern is located farther from the plane.

3. The panel of claim 1 wherein the gypsum based material is fiber reinforced gypsum.

4. The panel of claim 1 wherein the first surface of the backing member is complementarily formed with the three-dimensional relief pattern of the structural skin.

5. The panel of claim 1, further comprising:
at least one grommet extending from the structural skin, the grommet integrally cast with the structural skin, an opening extending through the grommet and the structural skin.

6. The panel of claim 1, further comprising:
a plurality of holes extending through the panel for mounting the panel to the interior surface, the holes formed concurrently during the casting of the structural skin and the moulding of the backing member.

7. The panel of claim 6 wherein the panel is structurally reinforced in the regions where at least some of the holes were formed in the panel.

8. The panel of claim 1 wherein the backing member is made from a plaster material mixed with perlite.

9. The panel of claim 8 wherein the backing member includes embedded fibers.

10. The panel of claim 1 wherein the three-dimensional relief pattern extends to at least one of the terminal edges of the panel.

11. The panel of claim 1 wherein a region adjacent to the terminal edge of the panel is not beveled.

12. The panel of claim 1 wherein an outstanding flange integrally and simultaneously cast with the structural skin forms at least one of the terminal edges of panel.

13. A modular system of composite panels for covering an interior surface of a building, the system comprising:
a plurality of panels with each panel abutted with at least one other panel, each panel having a hardened structural skin cast from a gypsum based material and a backing member having a first surface and a second surface, the first surface moulded to the structural skin, the second surface having a substantially flat portion, the backing member made from a material having a lower density than that of the structural skin, wherein the panel formed by the moulded structural skin and backing member includes a perimeter and a three-dimensional relief pattern, the amount of relief being variable over the area of panel relative to the substantially flat portion of the second surface of the backing member; and
a seamless transition from one panel to the next where the three-dimensional relief pattern is configured to produce a continuous, sculpted, visible surface covering the interior surface after the panel seams have been finished.

14. The system of claim 13 wherein a first portion of the three dimensional relief pattern is located closer to a plane coincident with the substantially flat portion of the second surface of the backing member and a second portion of the three dimensional relief pattern is located farther from the plane.

15. The system of claim 13 wherein the gypsum based material is fiber reinforced gypsum.

16. The system of claim 13 wherein the first surface of the backing member is complementarily formed with the three-dimensional relief pattern of the structural skin.

17. The system of claim 13, further comprising:
at least one grommet extending from the structural skin of at least one panel, the grommet integrally cast with the structural skin, an opening extending through the grommet and the structural skin.

18. The panel of claim 13, further comprising:
at least one grommet inserted into an opening in the structural skin of at least one of the panels.

19. The system of claim 13, further comprising:
a plurality of holes extending through the panels for mounting the panels to the interior surface, the holes formed concurrently during the casting of the structural skin and the moulding of the backing member.

20. The system of claim 19 wherein the panels are structurally reinforced in the regions where at least some of the holes were formed in the panels.

21. The panel of claim 13 wherein the backing member is made from a plaster material mixed with perlite.

22. The panel of claim 21 wherein the backing member includes embedded fibers.

23. The system of claim 13 wherein the three-dimensional relief pattern extends to at least one of the terminal edges of each of the panels.

24. The system of claim 13 wherein the terminal edges of the panels are not beveled.

25. The system of claim 13 wherein an outstanding flange integrally and simultaneously cast with the structural skin forms at least one of the terminal edges of at least one of the panels.

26. The system of claim 13 wherein the three-dimensional relief pattern on one panel abuts with a complementary three-dimensional relief pattern formed on at least one other adjacent panel.

27. A method of manufacturing a modular, composite panel, the method comprising:
directing a gypsum based material into a mould to create a cast, hardened structural skin with a three-dimensional relief pattern; and
moulding a backing member to the skin, the backing member made from a material having a lower density than that of the skin, a first surface of the backing member being affixed to the skin during the moulding process.

28. The method of claim 27, further comprising:
creating the mould using computer numerically controlled (CNC) machining techniques.

29. The method of claim 27 wherein directing the gypsum based material into the mould to create a cast, hardened skin includes the skin being formed with a number of mounting points, the mounting points reinforced with extended flanges projecting from one surface of the skin.

30. The method of claim 27 wherein directing the gypsum based material into the mould to create a cast, hardened skin includes perpendicular extending flanges projecting from the terminal edges of the skin, the flanges being integrally cast with the skin.

31. The method of claim 27 wherein directing the gypsum based material into the mould to create a cast, hardened skin includes directing a fiber reinforced gypsum slurry into the mould.

32. A method of affixing modular, composite panels to an interior surface of a building, the method comprising:
placing a first panel on the interior surface;
attaching the first panel to the interior surface;
placing a second panel on the interior surface and adjacently locating the second panel with the first panel;
aligning a three-dimensional relief pattern of the first panel with the three-dimensional relief pattern of the second panel;
attaching the second panel to the interior surface;
filling a seam between the adjacent panels with a filler; and
sanding the filled seam and proximately located regions on the panel to provide a seamless appearance.

33. The method of claim 32 wherein placing the panels on the interior surface includes placing the panels on existing wallboard.

34. The method of claim 32 wherein placing the panels on the interior surface includes placing the panels plumb and level.

35. The method of claim 32 wherein placing the panels on the interior surface includes marking the location of the panels on the interior surface with a marking object through at least two mounting locations pre-cast in the panels.

36. The method of claim 32, further comprising:
assuring that the terminal edge of the second panel is aligned with the similar terminal edge of the first panel.

37. The method of claim 32 wherein attaching the panels to the interior surface is accomplished with fasteners.

38. The method of claim 32 wherein attaching the panels to the interior surface is accomplished with fasteners and with using a countersinking drill bit.

39. The method of claim 38, further comprising:
filling the countersunk locations on the panels with a filler.

40. The method of claim 32 wherein attaching the panels to the interior surface is accomplished with adhesive.

41. The method of claim 32 wherein adhering the terminal edges of the panels includes using a polyurethane glue.

42. The method of claim 32 wherein filling the seams between adjacent panels with a filler includes using a filler that contains a vinyl additive.

43. The method of claim 32 wherein filling the seams between adjacent panels with a filler includes using a filler that contains an acrylic additive.

44. The method of claim 32 wherein filling the seams between adjacent panels with a filler includes using a filler that is a construction mastic.

45. The method of claim 32, further comprising:
sealing the panels with a sealer; and
painting the panels.

46. A panel for covering an interior surface, the panel comprising:
a first surface having a substantially flat portion;
a second surface opposed from the first surface, the second surface having a three-dimensional relief pattern, the amount of relief being variable over the area of panel relative to the substantially flat portion of the first surface; and
a plurality of terminal edges defining a perimeter of the panel.

47. The panel of claim 46 wherein the panel is made from a cement-based material.

48. The panel of claim 46 wherein the panel is made from a gypsum based material.
